(19) United States
(12) Patent Application Publication
(10) Pub. No.: US 2007/0165675 A1
(43) Pub. Date: Jul. 19, 2007

(54) Data conversion method and client-server system

(75) Inventor: Michiaki Yoneda, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/651,297

(22) Filed: Jan. 9, 2007

(30) Foreign Application Priority Data
Jan. 16, 2006 (JP) JP2006-006866

(51) Int. Cl. H04J 3/00

(52) U.S. Cl. 370/476; 370/487

(57) ABSTRACT

A data conversion method includes the steps of retrieving direct stream digital data one byte at a time from a direct stream digital file, the direct stream digital data being a one-bit data stream, the direct stream digital data being arranged in the direct stream digital file so that temporally first data is placed at a least significant bit of a given byte and temporally last data is placed at a most significant bit of the given byte; and outputting the retrieved direct stream digital data of one byte so that the least significant bit is temporally first and the most significant bit is temporally last.

### CROSS REFERENCES TO RELATED APPLICATIONS

The present invention contains subject matter related to Japanese Patent Application JP 2006-006866 filed in the Japanese Patent Office on Jan. 16, 2006, the entire contents of which are incorporated herein by reference.

### BACKGROUND OF THE INVENTION

1. Field of the Invention

The present invention relates to data conversion methods and client-server systems.

2. Description of the Related Art

In compact discs (CDs), digital audio data is a digital signal whose original analog audio signal is quantized into digital data of which one sample is composed of 16 bits using pulse code modulation (PCM). As shown in FIGS. 6A and 6B, there is known a method of converting an original analog audio signal (FIG. 6A) into a one-bit serial data stream (FIG. 6B) using delta-sigma (ΔΣ) modulation.

The digital data (FIG. 6B) obtained by the ΔΣ modulation is called direct stream digital (DSD) data. The DSD data is also a pulse-number modulated signal whose pulse number changes according to the amplitude of the original analog audio signal. By integrating the DSD data using a low pass filter, therefore, the DSD data can be converted into the original analog audio signal.

The DSD data is used as a data format in which music data (digital audio data to be reproduced as music) is recorded on and reproduced from a super audio CD (SACD), and provides high-quality recording and reproduction of music.

The DSD data is stored in a storage device or is recorded on a medium as a file. FIG. 7 shows a format of a DSD file into which the DSD data is converted. As shown in (A) of FIG. 7, the DSD file is composed of a header at the beginning of the file, and a plurality of frames following the header. The header defines the specification of the DSD file, containing information such as the overall size (the number of bytes) of the DSD file, the size of the header, the size of the frames, and the number of audio channels, and is variable in length.

Each frame includes DSD data (the bit stream shown in FIG. 6B) in units of bytes, where each byte is composed of eight bits, and a number of frames corresponding to the size of the DSD data are successively provided. The size of the frames is fixed in one DSD file. In FIG. 7, a frame has a length of 4096 bytes. In (A) of FIG. 7, the file format in two-channel stereo is illustrated, in which the odd-numbered frames include left-channel DSD data and the even-numbered frames include right-channel DSD data. Each of the left-channel frames and the succeeding right-channel frame temporally correspond to each other. That is, they are reproduced at the same timing.

As shown in (B) of FIG. 7, in a given frame, bytes B0 to B4095 of the DSD data are arranged in little-endian order. That is, the bytes are arranged in chronological order so that the temporally first information is placed at the first byte, namely, B0, and the temporally last information is placed at the last byte, namely, B4095. If the size of the DSD data is not an integer multiple of the size of the frames, the last frame has a blank area, and the blank area defines dummy data, e.g., “0”.

As shown in (C) of FIG. 7, in a given byte Bi (i=0 to 4095), bits b0 to b7 are provided in an LSB-first format. That is, the chronological order is depicted from the least significant bit (LSB) to the most significant bit (MSB) in such a manner that the LSB (namely, bit b0) defines the temporally first information and the MSB (namely, bit b7) defines the temporally last information.

In (D) of FIG. 7, the format of the DSD file in six-channel stereo is illustrated. In this case, every six frames of the DSD file is grouped, and each group of frames includes DSD data for the first to sixth channels. The specification of the frames is similar to that in two-channel stereo.

A technique of the related art is disclosed in “Supa Odyio CD—Supa Odyio CD toha (Super Audio CD—What is Super Audio CD?)”, Sony Corporation, Oct. 14, 2005, which is available from http://www.super-audiocd.com/aboutacd/format, searched Dec. 28, 2005.

### SUMMARY OF THE INVENTION

In client-server systems, various types of digital data are prepared in a server apparatus (hereinafter referred to as a “server”). In response to a request from a client apparatus (hereinafter referred to as a “client”), the server provides the requested digital data to the client via a network. The digital data provided from the server to the client includes various types of music data.

In a typical client-server system, a file is transmitted from a server to a client one bit at a time. In this case, within one byte, the MSB is transmitted first and the LSB is transmitted last.

Therefore, when a DSD file is transmitted from a server to a client, as shown in (C) of FIG. 7, within the byte Bi, the MSB is transmitted first and the LSB is transmitted last. That is, within the byte Bi, the information is transmitted in reverse order. Thus, even if the DSD file is prepared in the server, it is difficult for the client to directly use the DSD file.

It is therefore desirable to overcome the foregoing problem.

According to an embodiment of the present invention, there is provided a data conversion method including the steps of retrieving direct stream digital data one byte at a time from a direct stream digital file, the direct stream digital data being a one-bit data stream, the direct stream digital data being arranged in the direct stream digital file so that temporally first data is placed at a least significant bit of a given byte and temporally last data is placed at a most significant bit of the given byte; and outputting the retrieved direct stream digital data of one byte so that the least significant bit is temporally first and the most significant bit is temporally last.

According to another embodiment of the present invention, there is provided a data conversion method including the steps of retrieving direct stream digital data one byte at a time from a direct stream digital file, the direct stream digital data being a one-bit data stream, the direct stream digital data being arranged in the direct stream digital file so that temporally first data is placed at a most significant bit of a given byte and temporally last data is placed at a least significant bit of the given byte; and outputting the retrieved direct stream digital data of one byte so that the most significant bit is temporally first and the least significant bit is temporally last.

According to the embodiments of the present invention, therefore, in a client-server system, even if a server stores a file in the DSD format, a client can use the file.

### BRIEF DESCRIPTION OF THE DRAWINGS

FIG. 1 is a schematic diagram of a system according to an embodiment of the present invention;

FIG. 2 is a schematic diagram equivalently showing the main part of an embodiment of the present invention;

FIG. 3 is a diagram showing a file format;

FIG. 4 is a schematic diagram equivalently showing the main part of another embodiment of the present invention;

FIG. 5 is a flowchart showing a process according to an embodiment of the present invention;

FIGS. 6A and 6B are waveform diagrams showing DSD data according to an embodiment of the present invention; and

FIG. 7 is a diagram showing a file format.

### DESCRIPTION OF THE PREFERRED EMBODIMENTS

### Structure

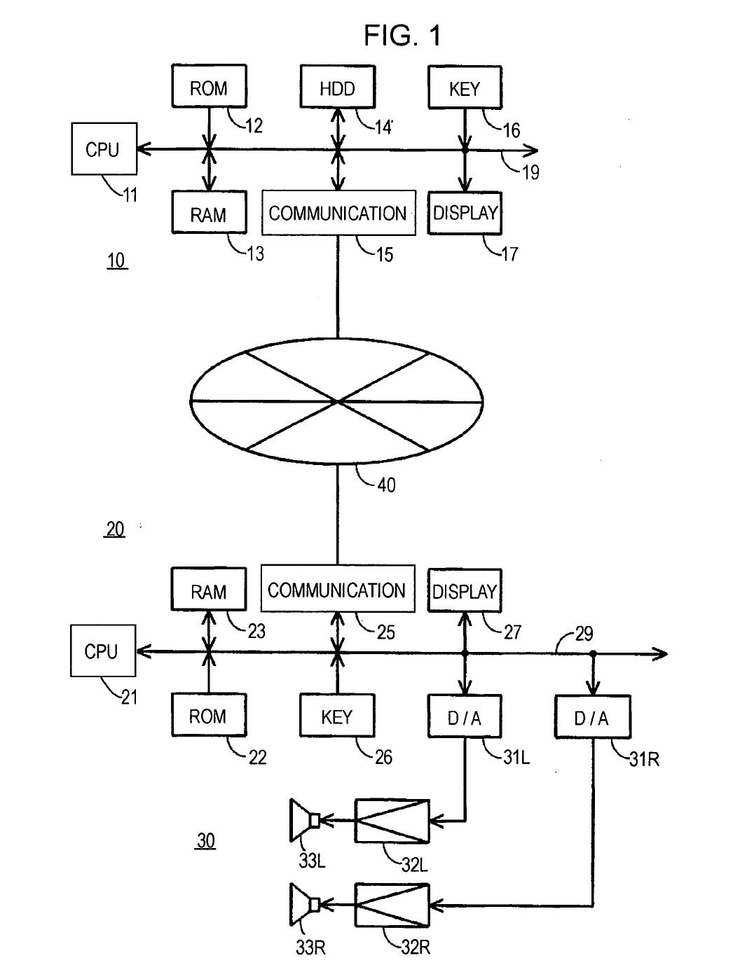

FIG. 1 shows an audio client-server system for home use according to an embodiment of the present invention. The client-server system includes a server 10, a client 20, and a network 40 such as a local area network (LAN).

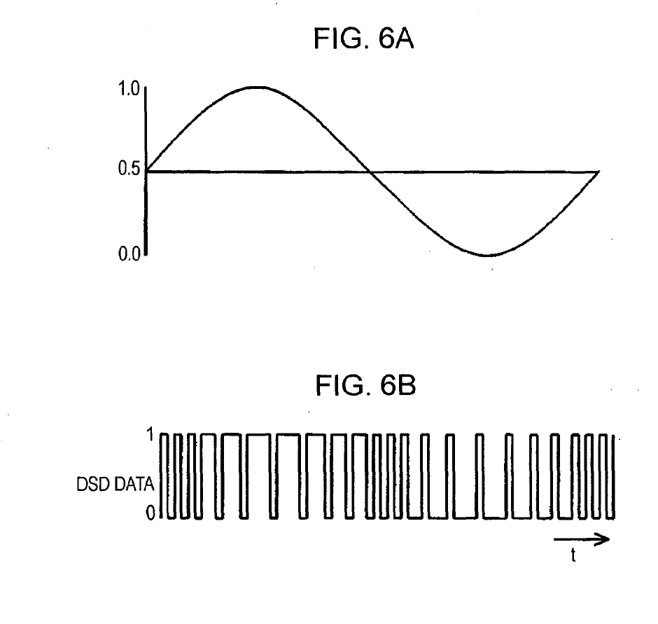

The server 10 includes a central processing unit (CPU) 11 configured to execute a program, a read only memory (ROM) 12 storing various programs, and a random access memory (RAM) 13 used as a work area. The CPU 11 and the memories 12 and 13 are connected to a system bus 19. A hard disk drive 14 as a large-capacity storage device is also connected to the system bus 19. The hard disk drive 14 is configured to store or accumulate music data of music to be provided to the client 20, and at least a portion of the music data is stored in the DSD file format described above with reference to FIGS. 6A and 6B.

The hard disk drive 14 further stores a table. The music stored in the hard disk drive 14 and information concerning the music data, such as album title, song name, artist name, sampling frequency, number of channels, and number of bits, are stored in the table. The information is used, for example, in response to a request from the client 20 to download music.

The server 10 further includes a communication interface 15. The communication interface 15 is configured to connect the server 10 to the client 20 via the network 40 using TCP/IP (Transmission Control Protocol/Internet Protocol). Therefore, the communication interface 15 is connected to the system bus 19, and is also connected to the network 40. The server 10 further includes various operation keys 16 and a display device 17, such as a light emitting diode (LED), as user interfaces for music administrators for allowing the operation or state of the server 10 to be monitored.

The client 20 includes a CPU 21 configured to execute a program, a ROM 22 storing various programs, and a RAM 23 used as a work area. The CPU 21 and the memories 22 and 23 are connected to a system bus 29. The ROM 22 stores a program for converting a DSD file transmitted from the server 10 into digital audio data suitable for audio reproduction. The processing of the conversion program is discussed in detail below.

The client 20 further includes a communication interface 25. The communication interface 25 is configured to connect the client 20 to the server 10 via the network 40 using TCP/IP. Therefore, the communication interface 25 is connected to the system bus 29, and is also connected to the network 40 to download music. The client 20 further includes various operation keys 26 and a display device 27, such as a liquid crystal display (LCD), as user interfaces for operating or monitoring the client 20.

In the embodiment, the client 20 further includes a music reproducing circuit 30 having D/A converter circuits 31L and 31R with one-bit input, and amplifiers 32L and 32R. The D/A converter circuits 31L and 31R are configured to convert, for example, the DSD data shown in FIG. 6B into the analog audio signal shown in FIG. 6A, and are formed of, for example, integrating circuits. The D/A converter circuits 31L and 31R are connected to the system bus 29, and are also connected to the amplifiers 32L and 32R. The amplifiers 32L and 32R are connected to speakers 33L and 33R.

### Operation

When a user is to reproduce a piece of music stored in the server 10, the user accesses the server 10 from the client 20 to specify the desired music. The user can specify the desired music by a general method, such as a method of directly entering the name of the desired music using the keys 26, or a method of narrowing down the choices of music in a hierarchical fashion each time the user enters a search condition, such as an artist name or an album title, so that the user can finally determine the name of the desired music.

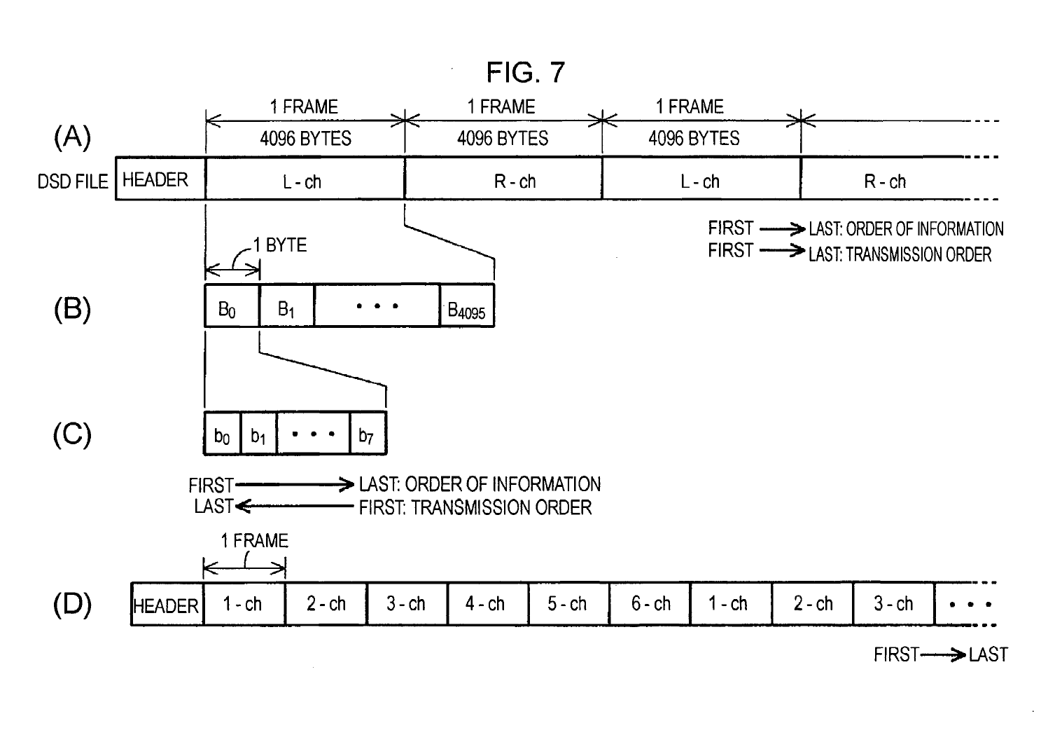

When the user specifies desired music, the server 10 refers to the table stored in the hard disk drive 14 to convert the specified music into the file name of the corresponding DSD file, and reads the DSD file (see FIG. 7) of the desired music based on the file name from the hard disk drive 14. The read DSD file is transmitted from the server 10 to the client 20 via the network 40.

The client 20 converts music data included in the frames of the DSD file into DSD data (the bit stream shown in FIG. 6B) for the left and right channels using a conversion method discussed below. The resulting left-channel and right-channel DSD data are supplied to the D/A converter circuits 31L and 31R for D/A conversion for D/A conversion into the original left-channel and right-channel analog audio signals, respectively, and the obtained signals are supplied to the speakers 33L and 33R via the amplifiers 32L and 32R to reproduce the music.

### Conversion from DSD File to DSD Data

A first method for converting a DSD file into DSD data will be discussed.

Since the DSD file is in the format shown in FIG. 7, the data of the left-channel frames and the data of the right-channel frames are synchronized to reproduce the audio signals from the DSD file. Further, within a given byte Bi, bit b0 is earlier subjected to D/A conversion. In the first conversion method, the CPU 21 performs processing to convert the DSD file into DSD data in the following manner.

When the DSD file transmitted from the server 10 is received by the client 20, the header of the DSD file is analyzed to extract information such as the size of the frames, the number of channels, and the sampling frequency, and the setting of the respective sections of the client 20 is performed according to the extracted information.

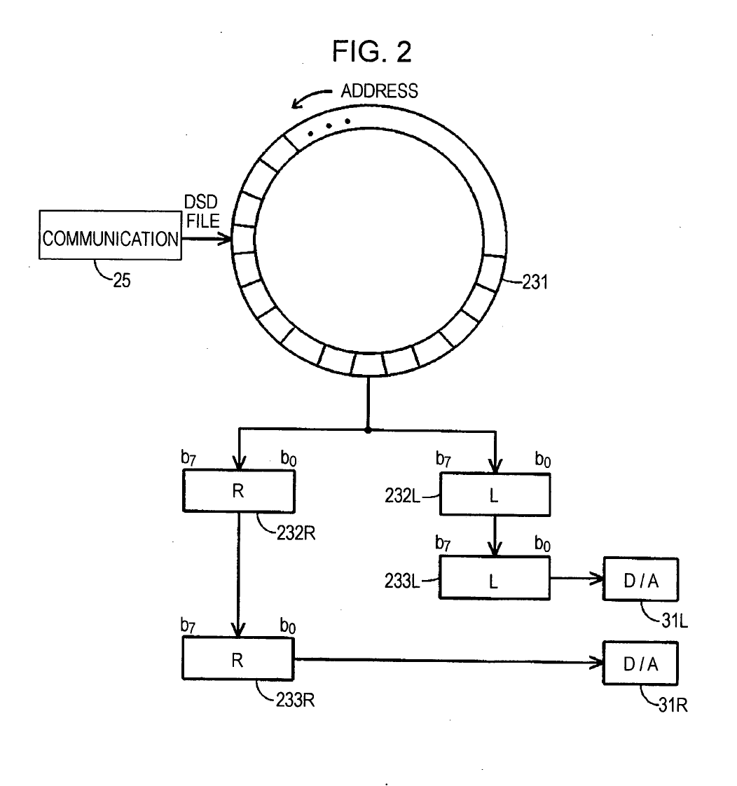

The CPU 21 executes a predetermined program, thereby equivalently providing the RAM 23 for, for example, as shown in FIG. 2, a ring buffer 231, latches 232L and 232R, and parallel-in/serial-out shift registers 233L and 233R. The ring buffer 231 has addresses each of which has a capacity of one byte. Each of the latches 232L and 232R and the shift registers 233L and 233R also has a capacity of one byte.

The frames of the received DSD file are sequentially written one byte at a time to the ring buffer 231. In the ring buffer 231, therefore, the left-channel data and the right-channel data shown in (A) of FIG. 7 are alternately written on a frame-by-frame basis with a one-to-one relation between the addresses and the bytes.

When a predetermined amount of data is written, the left-channel data and the right-channel data are read from the ring buffer 231 at the same time as the writing operation. In this case, the left-channel data and the right-channel data are read in the following order: one byte for the left channel, one byte for the right channel, next one byte for the left channel, next one byte for the right channel, and so forth.

That is, the reading of data from the ring buffer 231 is performed so that two addresses one frame apart from each other are alternately read on an address-by-address basis while the addresses to be read for each channel are changed on an address-by-address basis. Further, when the reading of one frame of data for two channels is performed, the addresses to be read are skipped by one frame. Accordingly, the left-channel data and the right-channel data in the DSD file are alternately retrieved one byte at a time from the ring buffer 231.

The retrieved data are alternately latched one byte at a time by the latches 232L and 232R, and are retrieved at the same time. The data bytes for the left channel are consecutively retrieved from the latch 232L while the data bytes for the right channel are consecutively retrieved from the latch 232R, and the data for both channels are synchronously retrieved.

The synchronously retrieved consecutive data for both channels are supplied one byte at a time in parallel to the shift registers 233L and 233R. The data are sequentially retrieved one bit at a time in series, starting from the LSB, from the shift registers 233L and 233R. Therefore, the DSD data shown in FIG. 6B is obtained from each of the shift registers 233L and 233R. That is, the DSD file is converted into DSD data. As described above, the DSD data is supplied to the D/A converter circuits 31L and 31R for conversion into the left-channel and right-channel analog audio signals.

A second method for converting a DSD file into DSD data will be discussed.

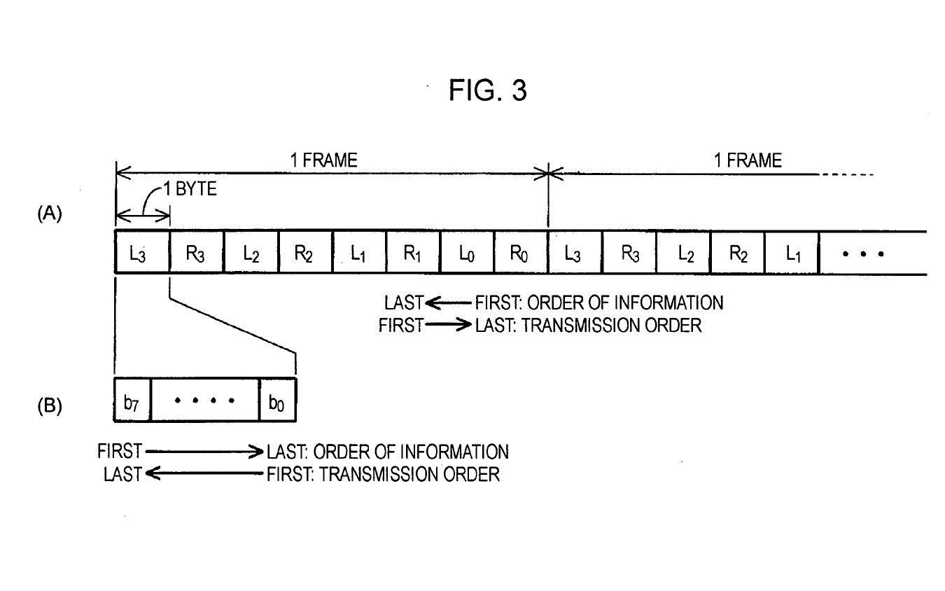

In the second conversion method, each of the frames of the DSD file has a configuration shown in FIG. 3. As shown in (A) of FIG. 3, one frame is composed of eight bytes, and data bytes L3 to L0 for the left channel and data bytes R3 to R0 for the right channel are alternately arranged. The data Lj (j=3 to 0) is arranged in big-endian order. That is, the bytes are arranged in reverse chronological order so that the temporally first information is placed at the last byte and the temporally last information is placed at the first byte. The data Rj is arranged in a similar manner.

Further, as shown in (B) of FIG. 3, in a given byte, bits b0 to b7 are provided in an MSB-first format. That is, the chronological order is depicted from the MSB to the LSB in such a manner that the MSB defines the temporally first information and the LSB defines the temporally last information.

The DSD file with the above-described frame configuration is transmitted from the server 10 to the client 20 so that, as shown in FIG. 3, each of the frames is transmitted starting from the data byte L3 in the order of the byte arrangement and each of the bytes is transmitted starting from the LSB in the order of the bit numbers.

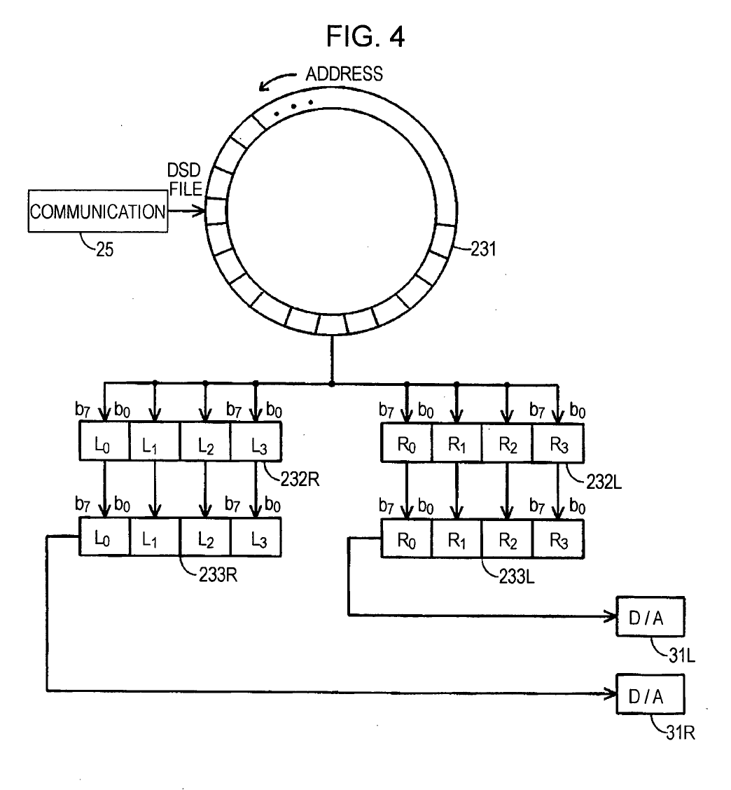

In the client 20, therefore, upon receiving the DSD file, the CPU 21 executes a predetermined program, thereby providing the RAM 23 for, for example, as shown in FIG. 4, a ring buffer 231, latches 232L and 232R, and parallel-in/serial-out shift registers 233L and 233R. The ring buffer 231 has addresses each of which has a capacity of one byte. Each of the latches 232L and 232R and the shift registers 233L and 233R have a capacity of four bytes.

The data Lj and Rj of the frames in the received DSD file are sequentially written to the ring buffer 231 so that one address corresponds to one byte. When a predetermined amount of data is written, the data Lj and Rj are read from the ring buffer 231 in the writing order at the same time as the writing operation, and the read data Lj and Rj are alternately latched one byte at a time by the latches 232L and 232R, respectively.

When the data L3 to L0 of a given frame are latched by the latch 232L and the data R3 to R0 of the given frame are latched by the latch 232R, the latched data Lj and Rj are simultaneously retrieved and are supplied in parallel to the shift registers 233L and 233R, respectively. The data Lj and Rj are sequentially retrieved one bit at a time in series, starting from bit b7 (MSB), from the shift registers 233L and 233R.

Therefore, the DSD data shown in FIG. 6B is obtained from each of the shift registers 233L and 233R. That is, the DSD file is converted into DSD data. As described above, the DSD data is supplied to the D/A converter circuits 31L and 31R for conversion into the left-channel and right-channel analog audio signals.

### Process for Receiving DSD File

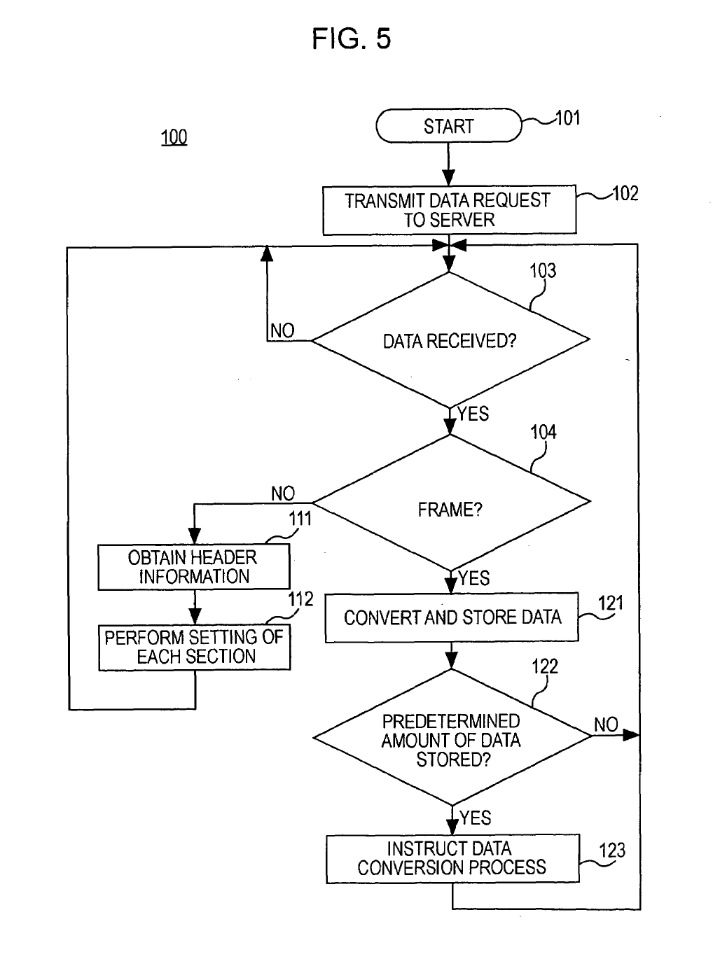

FIG. 5 shows an example processing routine 100 for the client 20 to receive a DSD file transmitted from the server 10. When the client 20 specifies desired music, in step 101, the CPU 21 performs a process according to the routine 100. In step 102, a request for transmission of music data of the specified music is transmitted from the client 20 to the server 10. The process proceeds to step 103. In step 103, the client 20 waits for reception of data.

In response to the request transmitted in step 102, the server 10 reads the DSD file (see FIG. 7) of the specified music from the hard disk drive 14, and transmits the read DSD file to the client 20 via the network 40.

In step 103, the client 20 detects the transmitted DSD file, and the process proceeds from step 103 to step 104. In step 104, it is determined whether or not the received data is data of a frame. In this case, the received data represents not a frame but the header, and the process proceeds from step 104 to step 111. In step 111, the header is continuously received, and the information contained in the header is extracted.

When the reception of the header has completed, the process proceeds to step 112. In step 112, the setting of the respective sections of the client 20, such as the ring buffer 231, is performed according to the extracted information of the header. Then, the process returns to step 103, and the client 20 waits for reception of a frame to be transmitted after the header.

When data is received, as described above, the process proceeds from step 103 to step 104. In this case, the received data represents a frame, and the process proceeds from step 104 to step 121. In step 121, the received data of the frame is written to the ring buffer 231. In step 122, it is determined whether or not a predetermined amount or more of data has been written in the ring buffer 231. If the predetermined amount of data has not yet been reached, the process returns to step 103 from step 122. In this way, the data of the frames of the DSD file transmitted from the server 10 is sequentially accumulated in the ring buffer 231.

As a result of the accumulation, if it is determined in step 122 that the predetermined amount or more of data has been written in the ring buffer 231, the process proceeds from step 122 to step 123. In step 123, an instruction for executing a routine for converting the data stored in the ring buffer 231 from the DSD file format to DSD data is issued. Then, the process returns to step 103.

The predetermined routine is thus executed according to the instruction issued in step 123, and the data in the ring buffer 231 is converted from the DSD file format to DSD data in the manner shown in FIG. 2. The resulting data is supplied to the D/A converter circuits 31L and 31R. Therefore, the music to be obtained by executing the routine 100 is output from the speakers 33L and 33R.

### Other Embodiments

In the foregoing description, a DSD file stored in the server 10 is directly transmitted to the client 20, and the client 20 converts the transmitted DSD file into DSD data. In an alternative embodiment, the server 10 may convert the DSD file retrieved from the hard disk drive 14 into DSD data, and may transmit the resulting DSD data to the client 20. This embodiment can reduce the load imposed on the client 20, thus giving more space to the CPU 21 to perform the processing.

Further, in the foregoing description, a DSD file transmitted from the server 10 is reproduced in real time as music. In an alternative embodiment, the client 20 may be provided with a storage device, such as a hard disk drive or a non-volatile memory, for storing the transmitted DSD file, and may reproduce the stored DSD file at any time. Instead of storing the DSD file, DSD data can be stored in a similar file format to standard digital data format.

Furthermore, when the server 10 transmits a DSD file to the client 20, if the format of the file is fixed, the transmission of the header may be omitted. Moreover, the ring buffer 231, the latches 232L and 232R, and the shift registers 233L and 233R can be implemented in hardware or by digital signal processors (DSPs).

It should be understood by those skilled in the art that various modifications, combinations, sub-combinations and alterations may occur depending on design requirements and other factors insofar as they are within the scope of the appended claims or the equivalents thereof.

What is claimed is:

1. A data conversion method comprising:
retrieving direct stream digital data one byte at a time from a direct stream digital file, the direct stream digital data being a one-bit data stream, the direct stream digital data being arranged in the direct stream digital file so that temporally-first data is placed at a least significant bit of a given byte and temporally-last data is placed at a most significant bit of the given byte; and
outputting the retrieved direct stream digital data of one byte so that the least significant bit is temporally first and the most significant bit is temporally last.

2. A data conversion method comprising:
retrieving direct stream digital data one byte at a time from a direct stream digital file, the direct stream digital data being a one-bit data stream, the direct stream digital data being arranged in the direct stream digital file so that temporally-first data is placed at a most significant bit of a given byte and temporally-last data is placed at a least significant bit of the given byte; and
outputting the retrieved direct stream digital data of one byte so that the most significant bit is temporally first and the least significant bit is temporally last.

3. A data conversion method comprising:
retrieving direct stream digital data for each audio channel one byte at a time from a direct stream digital file, the direct stream digital data including frames for at least a first audio channel and a second audio channel, the frames being alternately arranged in order of a frame for the first audio channel and a frame for the second audio channel, each of the frames being a one-bit data stream, the direct stream digital data being arranged in the direct stream digital file so that temporally first data is placed at a least significant bit of a given byte and temporally last data is placed at a most significant bit of the given byte; and
outputting the retrieved direct stream digital data of one byte so that the least significant bit is temporally first and the most significant bit is temporally last.

4. A data conversion method comprising:
retrieving direct stream digital data for each audio channel one byte at a time from a direct stream digital file, the direct stream digital data including frames for at least a first audio channel and a second audio channel, the frames being alternately arranged in order of a frame for the first audio channel and a frame for the second audio channel, each of the frames being a one-bit data stream, the direct stream digital data being arranged in the direct stream digital file so that temporally-first data is placed at a most significant bit of a given byte and temporally-last data is placed at a least significant bit of the given byte; and
outputting the retrieved direct stream digital data of one byte so that the most significant bit is temporally first and the least significant bit is temporally last.

5. A client-server system comprising:
a client apparatus; and
a server apparatus,
wherein the server apparatus transmits a direct stream digital file including direct stream digital data to the client apparatus, the direct stream digital data including frames for at least a first audio channel and a second audio channel, the frames being alternately arranged in order of a frame for the first audio channel and a frame for the second audio channel, each of the frames being a one-bit data stream, the direct stream digital data being arranged in the direct stream digital file so that temporally-first data is placed at a least significant bit of a given byte and temporally-last data is placed at a most significant bit of the given byte,
the client apparatus receives the direct stream digital file transmitted from the server apparatus,
the client apparatus retrieves the direct stream digital data for each of the first audio channel and the second audio channel one byte at a time from the received direct stream digital file, and
the client apparatus performs digital-to-analog conversion on the retrieved direct stream digital data of one byte so that the least significant bit is temporally first and the most significant bit is temporally last.

6. A client-server system comprising:
a client apparatus; and
a server apparatus,
wherein the server apparatus transmits a direct stream digital file including direct stream digital data to the client apparatus, the direct stream digital data including frames for at least a first audio channel and a second audio channel, the frames being alternately arranged in order of a frame for the first audio channel and a frame for the second audio channel, each of the frames being a one-bit data stream, the direct stream digital data being arranged in the direct stream digital file so that temporally-first data is placed at a most significant bit of a given byte and temporally-last data is placed at a least significant bit of the given byte,
the client apparatus receives the direct stream digital file transmitted from the server apparatus,
the client apparatus retrieves the direct stream digital data for each of the first audio channel and the second audio channel one byte at a time from the received direct stream digital file, and
the client apparatus performs digital-to-analog conversion on the retrieved direct stream digital data of one byte so that the most significant bit is temporally first and the least significant bit is temporally last.
